(19) United States
(12) Patent Application Publication
(10) Pub. No.: US 2020/0108363 A1
(43) Pub. Date: Apr. 9, 2020

(54) Blending appliance

(71) Applicant: Blend Vending LLC, Chicago, IL (US)

(72) Inventor: Richard Riback L. Riback, Highland Park, IL (US)

(21) Appl. No.: 16/350,332

(22) Filed: Nov. 2, 2018

Related U.S. Application Data
(60) Provisional application No. 62/766,249, filed on Oct. 9, 2018.

(51) Int. Cl. B01F 11/00; B01F 15/00; B65D 1/26; B65D 1/44; B65D 53/08; B65D 43/02; A47G 19/22

(52) U.S. Cl. CPC B01F 11/0022; B01F 11/0011; B01F 11/0097; B01F 15/00538; B65D 1/265; B65D 2543/00351; B65D 53/08; B65D 43/0235; A47G 19/2222; B65D 2543/00842; B65D 2543/00092; B65D 1/44

(57) ABSTRACT

A blending appliance in accordance with the principals of the present invention includes a linear motor drive comprising a magnet structure secured to a reaction mass and a coil structure secured to a shaker platen, the shaker platen adapted to secure a blending cup. A third mass is secured to the reaction mass via at least one biasing member. A ground is secured to the third mass via at least one biasing member. The shaker platen is secured to the reaction mass via at least one biasing member. The magnet structure and coil structure impart a force to the reaction mass and the shaker platen, which force is driven by the biasing members and the masses of the shaker platen, the reaction mass, and the third mass into resonance, thereby maximizing payload amplitude, minimizing forces transmitted to ground, and minimizing driver amplitude. The smoothie blending cup comprising structure to generate at least two forces applied upon the smoothie ingredients, the forces selected from the group consisting of pulverizing force, shear force, rotational-kinetic energy force, radial-kinetic energy force, and combinations thereof. The smoothie blending cup and cap can be sealed with the beverage ingredients contained therein at the point of manufacture.

### RELATED APPLICATIONS

This application claims priority from U.S. Provisional Patent Application Ser. No. 62/766,249, filed 9 Oct. 2018 entitled “Blending Appliance”.

### FIELD OF THE INVENTION

The present invention relates to beverage production.

### BACKGROUND OF THE INVENTION

A smoothie (occasionally spelled smoothee or smoothy) is a thick, usually cold beverage made from pureed fruit and sometimes vegetables. Smoothies often include other ingredients such as, for example, water, crushed ice, fruit juice, sweeteners (for example, honey, coconut sugar, molasses, maple syrup, etc.), dairy products such as, for example, milk, yogurt, cottage cheese, whey powder, etc.), plant milk, nuts, nut butter, seeds, chocolate, and herbal and/or nutritional supplements.

Given today's ‘on-the-go’ consumer lifestyle, smoothies often act as a meal replacement; however, while generally perceived as a health food, the healthfulness of smoothies depends on the ingredients and proportions. Many smoothies include multiple servings of fruits and vegetables, which are recommended in a healthy diet; however, too many sweet fruits and/or too much fruit juice can lead to too much sugar. Similarly, ingredients such as, for example, protein powders, sweeteners or ice cream are often used in smoothie recipes, some of which are not necessarily healthful.

Because smoothies are made from whole fruits and vegetables, smoothies include dietary fiber (for example, pulp, skin, seeds, etc.) and so are thicker than fruit juice, often with a consistency similar to a milkshake. The fiber makes smoothies more healthful than fruit juice, which can be as unhealthful as soda pop. Smoothies—particularly “green” smoothies that include vegetables—are often marketed as a health-conscious alternative to soda, fruit juice, and milkshakes.

“Green” smoothies typically include a higher percentage of green vegetables such as, for example, green leafy vegetables such as spinach, kale, Swiss chard, collard greens, celery, parsley, broccoli, etc. Because of the perceived health benefits, green smoothies recently have grown rapidly in popularity; unfortunately, because many green leafy vegetables can have a bitter flavor, many commercially available green smoothies contain small amounts of green vegetables.

While marketing these products as healthy, because of the small amount of green leafy vegetables as well as the presence of other less than healthy ingredients (such as, for example, high fructose corn syrup, canned fruits (high in added sugar), fruit juices (flavored sugar water), protean powders (many have fillers), etc.) this marketing at least boarders on consumer fraud. See, for example, Rick Archer, “Jamba Juice Smoothies Not Healthy as Advertised, Suit Says”, Law360 (23 Aug. 2018) (available at https://www.law360.com/articles/1076342/jamba-juice-smoothies-not-healthy-as-advertised-suit-says (accessed 19 Sep. 2018)).

What would thus be beneficial would be an appliance that would enable smoothies to be easily and professionally produced.

There was no defining “invention” of the smoothie. For hundreds of years, Mediterranean and Eastern cultures have served pureed fruit drinks that resemble what are now called smoothies; however, it was not until the invention of home refrigeration in the 1910s and the electric blender in the 1930s that Americans began consuming these blended fruits. A blender is a kitchen appliance used to mix, puree or emulsify food and other substances. A blender consists of a blender jar with rotating metal blades at the bottom, powered by an electric motor in the base.

Making smoothies with blenders, however, raises several drawbacks. Cleaning a blender entails separating the blender jar, the rotating metal blades, and the electric motor in the base. Once separated the blender jar can simply be washed as with any food container. It also is relatively straightforward to wipe down the base to avoid immersing the base into a liquid—which could cause considerable damage to the electric motor. However, cleaning the moving parts associated with connecting the electric motor contained outside the blender jar with the rotating metal blades contained within the blending jar without causing damage from a liquid can be difficult and time consuming.

Some non-retail blender designs have incorporated so-called integrated internal cleaning systems that spray cleaning fluid through nozzles into the blending chamber in an attempt to automatically clean the blender. Even putting aside the potential sanitation risks inherent in the implementation of such robotic efforts, such systems add considerable to the complexity and thus cost of the commercial blenders.

What would thus be additionally beneficial would be an appliance that would enable smoothies to be easily and professionally produced without necessitating a difficult, time consuming, and costly clean up.

In addition, many believe subjecting fruits and vegetables to the destructive forces unleased by the rapidly rotating metal blades of an electronic blender can adversely affect the nutritional value of the smoothie. Fruits and vegetables have fibers that play an important role in slowing down the digestion of food and regulating blood sugar. When fruits and vegetables are subjected to the rapidly rotating metal blades of an electronic blender, the fiber is broken down—essentially pre-digested. Thus, subjecting fruits and vegetables to rapidly rotating metal blades minimizes the beneficial effects on digestion of food and regulating blood sugar of fiber gained by eating fruits and vegetables.

In addition, the rapidly rotating metal blades of an electronic blender can generate heat which, when the fruits and vegetables are subjected, can destroy nutrients. Also, blender blades are designed to pull down the ingredients in the blender jar, which also can pull down into the blades excessive amounts of oxygen. Of course, exposing fruits and vegetables to oxygen causes oxidation, which exposure in turn causes degradation of nutrients. See Kevin Gianni, “Dr. Brian Clement on Blending Foods #510), YOUTUBE (Feb. 22, 2010), (available at https://www.youtube.com/watch?v=C0fL7MQON5A&feature=related (at 4:95) (accessed 19 Sep. 2018)).

Thus, what would still further be beneficial would be an appliance that would enable smoothies to be easily and professionally produced while avoiding the potentially destructive forces unleased by subjecting the smoothie ingredients to the rapidly rotating metal blades.

### SUMMARY OF THE INVENTION

A smoothie blending appliance in accordance with the principals of the present invention enables smoothies to be easily and professionally produced. A smoothie blending appliance in accordance with the principals of the present invention allows smoothies to be easily and professionally produced without necessitating a difficult and time consuming clean up. A smoothie blending appliance in accordance with the principals of the present invention avoids the potential destructive forces unleased by subjecting the smoothie ingredients to rapidly rotating metal blades.

In an aspect in accordance with the principals of the present invention, a smoothie blending appliance includes a linear motor drive comprising a magnet structure secured to a reaction mass and a coil structure secured to a shaker platen, the shaker platen adapted to secure a blending cup. A third mass is secured to the reaction mass via at least one biasing member. A ground is secured to the third mass via at least one biasing member. The shaker platen is secured to the reaction mass via at least one biasing member. The magnet structure and coil structure impart a force the reaction mass and the shaker platen that is both equal in force but opposite in direction simultaneously to both of these masses. The force application frequency is selected to be at or near the natural frequency of the system and stimulates the system into resonance, thereby maximizing payload amplitude, minimizing forces transmitted to ground, and minimizing driver force.

In an aspect in accordance with the principals of the present invention, the blending cup comprising structure to generate at least two forces applied upon the smoothie ingredients. The forces can be selected from the group consisting of pulverizing force, shear force, rotational-kinetic energy force, radial-kinetic energy force, and combinations thereof. The pulverizing force can be imparted upon the smoothie ingredients by a lower center spike in combination with a plurality of fins located at the upper periphery of the cup. The shear force can be imparted upon the smoothie ingredients by a plurality of stepped shelves located at the outer lower periphery of the cup. The rotational-kinetic energy force can be imparted upon the smoothie ingredients by a plurality of angled steppes located at the inner lower periphery of the cup. The radial-kinetic energy force can be imparted upon the smoothie ingredients by the center spike. Other blending and mixing forces are produced as result of the resonant shaking energy that is directed directly into the beverage contents of the blending cup. The blending cup can be sealed at the point of manufacture.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The Detailed Description refers to the following accompanying drawings:

FIG. 1 is a perspective view of a blending appliance in accordance with the principals of the present invention.

FIG. 2 is a side-elevational view of the blending appliance of FIG. 1.

FIG. 3 is a top view of the blending appliance of FIG. 1.

FIG. 4 is a cross-sectional view of the blending appliance of FIG. 1 taken along the line A-A of FIG. 3.

FIG. 5 is a cross-sectional view of a blending appliance of FIG. 1 taken along the line B-B of FIG. 3.

FIG. 6a is a free-body schematic diagram of the mechanical system of the blending appliance of FIGS. 1-5.

FIG. 6b is a free-body schematic diagram of a mechanical system of a blending appliance where the spring pairs k1/k2, k3/k4 and dampening pairs c1/c2, c3/c4 of FIG. 6a have been replaced with single elements to simplify the equations of motion.

FIG. 7 is a perspective view of a blending cup, cap, and seal assembly in accordance with the principals of the present invention.

FIG. 8 is an elevated view of the blending cup, cap, and seal assembly of FIG. 6.

FIG. 9 is a cross-sectional view of the blending cup, cap, and seal assembly of FIG. 6 taken along the line A-A of FIG. 8.

FIG. 10 is a cross-sectional view of the blending cup, cap, and seal assembly of FIG. 6 taken along the line B-B of FIG. 8.

FIG. 11 is a cross-sectional view of the blending cup, cap, and seal assembly of Figure taken along the line C-C of FIG. 8.

FIG. 12a is a perspective detailed view of an embodiment in which the blending cup and cap are sealed at the point of manufacture.

FIG. 12b is a perspective detailed view of the embodiment of FIG. 12a where lidding stock covering an access aperture has been pierced so the beverage contents can be accessed by a straw.

FIG. 13a is a perspective view of the use of an embodiment in which the blending cup and cap are sealed at the point of manufacture.

FIG. 13b is a perspective view of the blending cup and cap of FIG. 13a with a user grasping a tear tab that can be utilized for shrink seal removal.

FIG. 13c is a perspective view of the blending cup and cap of FIG. 13a with a user removing the strippable shrink seal.

FIG. 13d is a perspective view of the blending cup and cap of FIG. 13a with the cap removed so the beverage contents can be accessed by a spoon.

### DETAILED DESCRIPTION OF EMBODIMENTS

In accordance with the principals of the present invention, a blending appliance is provided. A linear motor such as for example a voice-coil motor drives a mechanical system into resonance. Due to the blending cup internal design the shaking action at resonance generates pulverizing, shear, rotational-kinetic energy, and radial-kinetic energy forces upon the ingredients. Other blending and mixing forces are produced as result of the resonant shaking energy that is directed directly into the beverage contents of the blending cup. These are direct shear forces between the content product as well as frictional heat energy of the frozen and semi frozen content.

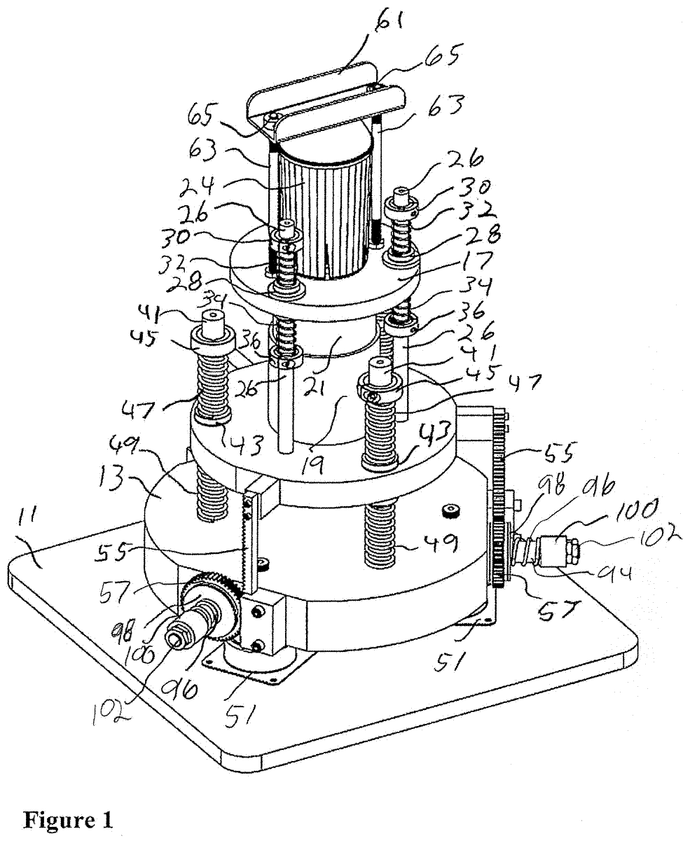

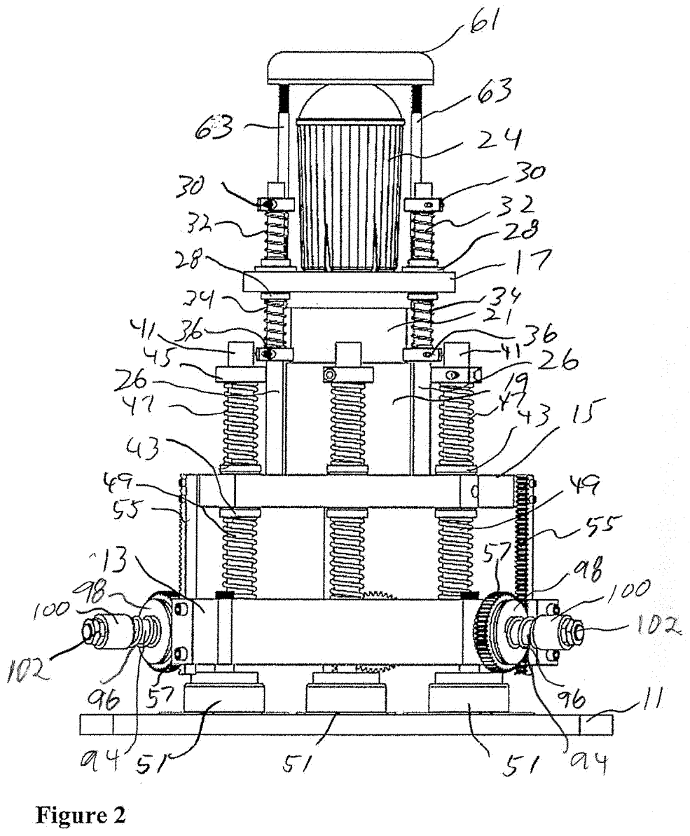

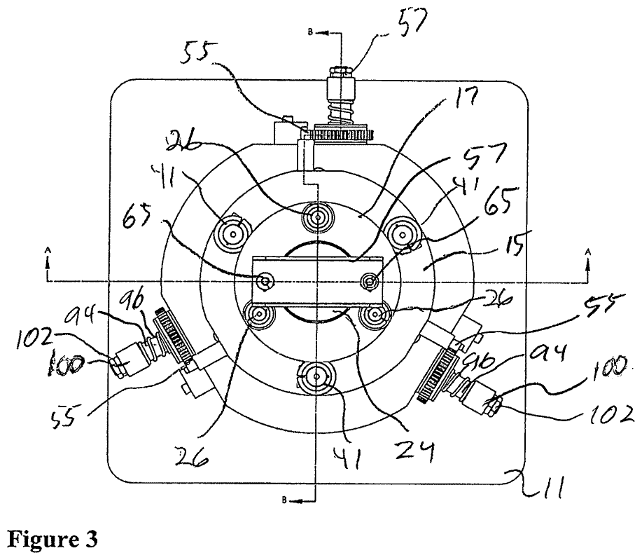

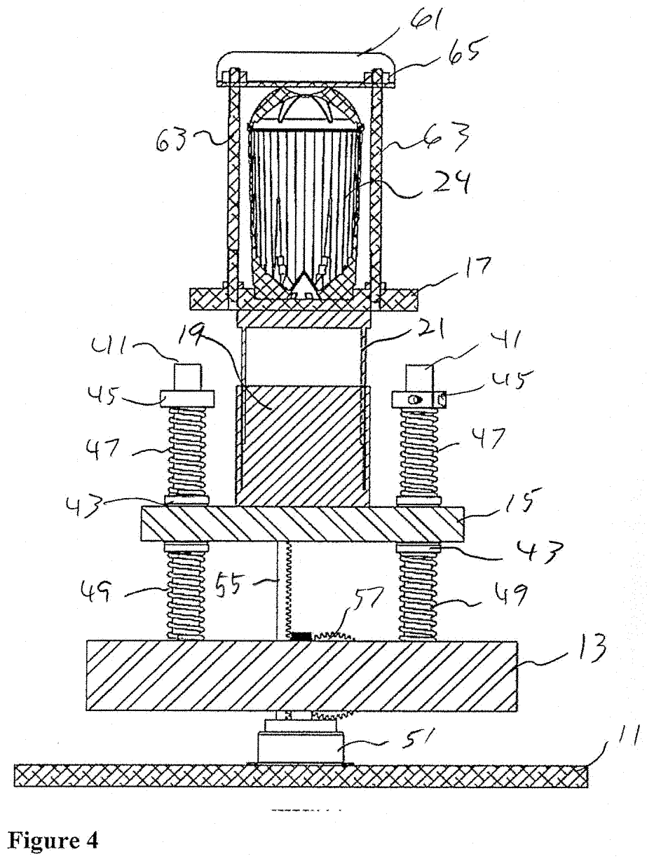

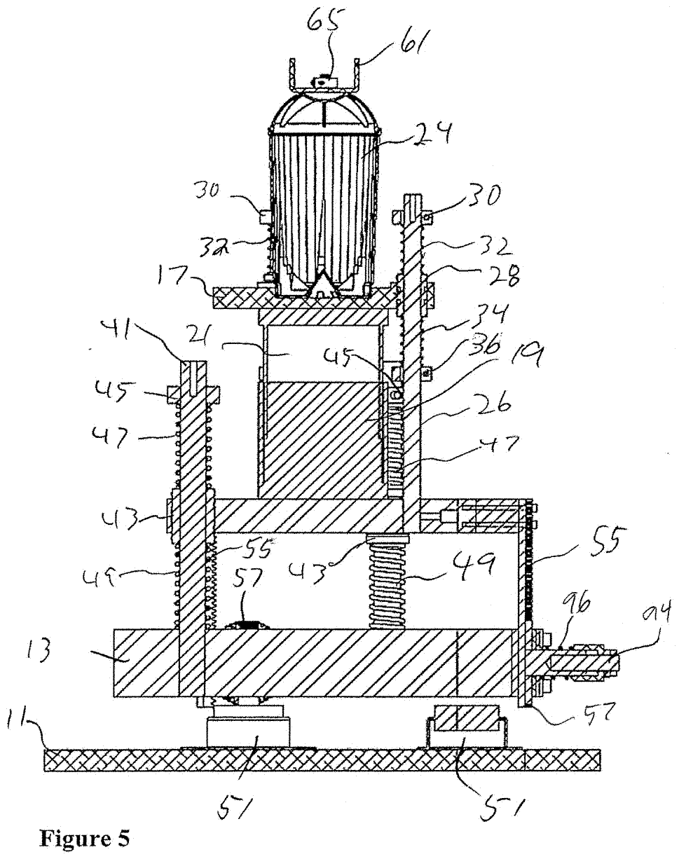

Referring to FIGS. 1-5, a perspective view, a side-elevational view, a top view, and two cross-sectional views of a blending appliance in accordance with the principals of the present invention are depicted. In this described embodiment, the blending appliance is designed to blend a smoothie; for convenience, the described embodiment will thus be non-limitedly referred to as the smoothie blending appliance. The design includes a grounded base plate 11, a third mass 13, a reaction mass 15, and a shaker platen 17. A voice coil motor includes a magnet structure 19 and a coil structure 21. The magnet structure 19 is secured to the reaction mass 15. The coil structure 21 is secured to the shaker platen 17. A blending cup, cap, and seal assembly 24 are secured to the shaker platen 17, as detailed below.

A plurality of guide shafts, such as for example three platen guide shafts 26, define vertical movement of the shaker platen 17. The platen guide shafts 26 are secured to the reaction mass 15. Contained on the shaker platen 17, a platen bushing 28 contains the platen guide shaft 26 that produces on the shaker platen 17 a constant mechanical damping in which energy is absorbed via sliding friction generated by the relative motion of the two surfaces that press against each other, referred to as Coulomb damping. A collar 30 on the platen guide shaft 26 helps adjust the force on the shaker platen 17. A biasing member such as a platen spring 32 on the platen guide shaft 26 is contained between the platen bushing 28 and the collar 30. Likewise, contained on the lower side of the shaker platen 17 a biasing member such as a second platen spring 34 can be contained on the platen guide shaft 26 beneath the platen bushing 28 and a second collar 36.

Likewise, a plurality of reaction guide shafts 41, such as for example three reaction guide shafts 41, define vertical movement of the reaction mass 15. The reaction guide shafts 41 are secured to the third mass 13. Contained on the reaction mass 15, a reaction bushing 43 contains the reaction guide shaft 41 and helps reduce vibrations on the reaction mass 15. A biasing member such as a reaction spring 47 on the reaction guide shaft 41 is contained between the reaction bushing 43 and the collar 45. Likewise, contained on the lower side of the reaction mass 15 a biasing member such as a second reaction spring 49 can be contained on the reaction guide shaft 41 beneath reaction bushing 43 and the third mass 13.

The third mass 13 is connected to the grounded base plate 11 by a plurality of standard isolation mounts such as for example a viscus isolator 51. An example viscus isolator is available from Lord Corporation, 111 Lord Drive, Cary, N.C. 27511. The third mass 13 also can be connected to the grounded base plate 11 by a plurality of linear actuators such as a rack and pinion. The rack and pinion includes a rack 55 connected to the reaction mass 15 and a pinion 57 connecting the third mass 13 to the rack 55. By imparting linear motion on the rack 55, rack teeth engage teeth on the rotational pinion 57 causing the pinion 57 to move relative to the rack 55, thereby translating the linear motion of the rack 55 into rotary motion of the pinion 57.

The pinion 57 is secured on a shaft 94. Contained on the shaft 94 is a spring 96 held between a flat washer 98 and an adjusting collar 100. The adjusting collar 100 can be adjusted by an adjusting nut 102 contained on the shaft 94. On the side of the flat washer 98 opposite the spring 96 is a low friction washer (not seen) such as for example a Teflon® washer that contacts the pinion 57. Teflon® is a registered trademark of E. I. Du Pont De Nemours and Company, 1007 Market Street, Wilmington Del. 19898. By adjusting the tension of the spring 96 by turning the adjusting nut 102 to move the adjusting collar 100 laterally, the friction on the pinion 57 is adjusted. This in turn varies the dampening on the mechanical system. By varying the dampening, the mechanical system can be “tuned” to thereby maximizing payload amplitude, minimizing forces transmitted to ground, and minimizing driver force.

The blending cup, cap, and seal assembly 24 are carried on the shaker platen 17. The blending cup, cap, and seal assembly 24 are secured to the shaker platen 17 by a hold down channel 61, a hold down stud 63, and a collar nut 65 for the hold down stud 63. Of course, other types of hold down systems such as swing clamps, toggles, etc. can be employed.

In operation, the voice-coil motor magnet structure 19 and coil structure 21 impart periodic stimulating forces with a frequency that is selected to be at or near the natural frequency of the mechanical system. The resulting resonance motion is an up and down movement imparted upon the shaker platen 17 and in turn is applied to the blending cup, cap, and seal assembly 24 and thus upon the smoothie ingredients contained therein.

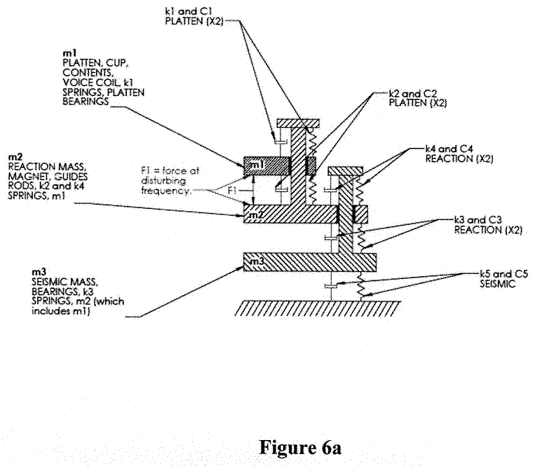

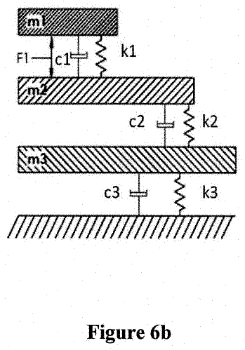

Referring to FIG. 6A, a free-body schematic diagram of the mechanical system of the smoothie blending appliance of FIGS. 1-5 is seen. In the schematic the base plate 11 is seen as ground; the third mass 13 is seen as m3; the reaction mass 15 is seen as m2; and the shaker platen 17 is seen as m1. The blending object—the blending cup, cap, and seal assembly 24—are carried on the shaker platen m1. Referring to FIG. 6B, a free-body schematic diagram of a mechanical system of a smoothie blending appliance where the spring pairs k1/k2, k3/k4 and dampening pairs c1/c2, c3/c4 of FIG. 6a have been replaced with single elements to simplify the equations of motion. The following are the equations of motion of the mechanical system of the smoothie blending appliance of FIG. 6B in the coordinate (Newtonian) form:

$${m}_{1} \frac{{d}^{2} {x}_{1}}{{dt}^{2}} = ( {c}_{1} + {c}_{2} ) \frac{{dx}_{1}}{dt} - {c}_{2} \frac{{dx}_{2}}{dt} + ( {k}_{1} + {k}_{2} ) {x}_{1} - {k}_{2} {x}_{2} + {f}_{1} ( t )$$

$${m}_{2} \frac{{d}^{2} {x}_{2}}{{dt}^{2}} = - {c}_{2} \frac{{dx}_{1}}{dt} + ( {c}_{2} + {c}_{3} ) \frac{{dx}_{2}}{dt} - {c}_{3} \frac{{dx}_{3}}{dt} - {k}_{2} {x}_{1} + ( {k}_{2} + {k}_{3} ) {x}_{2} - {k}_{3} {x}_{3} + {f}_{2} ( t )$$

$${m}_{3} \frac{{d}^{2} {x}_{3}}{{dt}^{2}} = - {c}_{3} \frac{{dx}_{2}}{dt} + {c}_{3} \frac{{dx}_{3}}{dt} - {k}_{3} {x}_{2} + {k}_{3} {x}_{3} + {f}_{3} ( t )$$

The following is the equations of motion of the mechanical system of the smoothie blending appliance of FIG. 6B in the Matrix form:

M\ddot{X}=C\dot{X}+KX+F

where the mass matrix (M), the damping matrix (C), the stiffness matrix (K), and the force matrix (F) are:

$$M = ( \begin{matrix}{m}_{1} & 0 & 0 \\ 0 & {m}_{2} & 0 \\ 0 & 0 & {m}_{3}\end{matrix} ) ; C = ( \begin{matrix}{c}_{1} + {c}_{2} & - {c}_{2} & 0 \\ - {c}_{2} & {c}_{2} + {c}_{3} & - {c}_{3} \\ 0 & - {c}_{3} & {c}_{3}\end{matrix} ) ; K = ( \begin{matrix}{k}_{1} + {k}_{2} & - {k}_{2} & 0 \\ - {k}_{2} & {k}_{2} + {k}_{3} & - {k}_{3} \\ 0 & - {k}_{3} & {k}_{3}\end{matrix} ) ;$$

$$F = ( \begin{matrix}{f}_{1} ( t ) \\ {f}_{2} ( t ) \\ {f}_{3} ( t )\end{matrix} ) ;$$

where:
mᵢ=mass;
kᵢ=spring rate of spring;
cᵢ=damping coefficient of dash pot;
xᵢ=position of mass; and
fᵢ=applied force.

By solving these equations, appropriate weights for the masses and appropriate spring rates and damping coefficients for the springs can be selected for preferred embodiments of the invention. In general, the selection of mass and spring sizes are subject to maximizing payload amplitude, minimizing forces transmitted to ground, and minimizing driver force. The dashpot constants are a result of natural damping and are not actual components. Therefore, the values of dashpot constants are preferably determined by testing after an embodiment is fabricated.

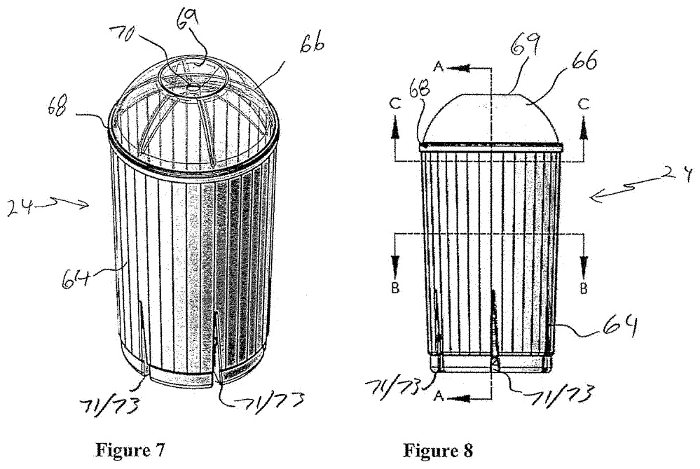

As previously described, the blending cup, cap, and seal assembly 24 are secured to the shaker platen 17. Referring to FIGS. 7 and 8, a perspective view and an elevated side view of a blending cup, cap, and seal assembly 24 in accordance with the principals of the present invention is seen. A blending cup 64 can be attached to a cap 66 by a seal assembly 68. The cap 66 defines a central recess 69. In the central recess 69, an access aperture 70 is defined through which the beverage contents of the blending cup 64 can be accessed by for example a straw (not shown) and is sealed with a film or foil film and subsequently can be removed or pierced by the consumer.

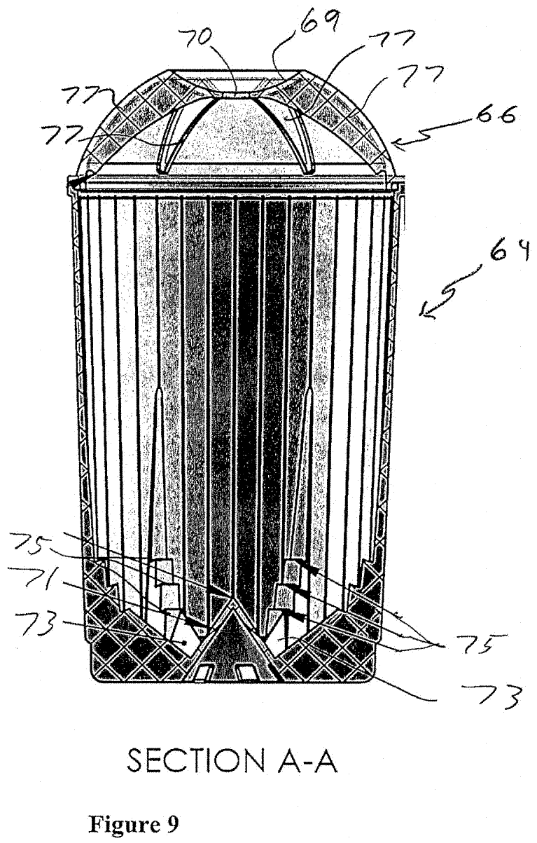

Referring to FIG. 9, a cross-sectional view of the blending cup 64, cap 66, and seal assembly 68 of FIG. 7 is seen. FIG. 9 is a cross-sectional view taken along the line A-A of FIG. 8. As previously described, the linear motor drives a mechanical system into resonance, causing the blending cup 64, cap 66, and seal assembly 68 to generate pulverizing, shear, rotational-kinetic energy, and radial-kinetic energy forces upon the smoothie ingredients.

By pulverizing what is meant is to reduce (as by crushing, beating or grinding) to very small particles. By shear force what is meant is a force that acts on a plane passing through the body. Shear forces are forces that are unaligned and separates structure in to two different parts in inverse direction. The shear force acts in a perpendicular direction to the length of the blending cup. By rotational-kinetic energy force what is meant is energy that results by virtue of the ingredients being in rotational motion.

By radial-kinetic energy force what is meant is energy that results by virtue of the ingredients being in vertical motion. The radial kinetic energy force can be imparted by a lower center spike 71 seen in FIG. 9 as the voice-coil motor magnet structure 19 and coil structure 21 impart an up and down movement upon the blending cup, cap, and seal assembly, and thus upon the smoothie ingredients therein.

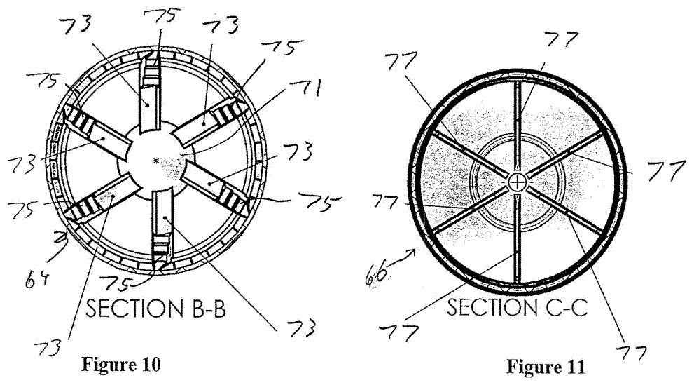

The rotational kinetic energy force can be imparted by a plurality of angled steppes 73 located at the inner lower periphery of the blending cup 64. Referring to FIG. 10, a cross-sectional view of the blending cup 64, cap 6 so the beverage contents can be accessed by a spoon 6, and seal assembly 68 of FIG. 7 taken along the line B-B of FIG. 8 is seen. FIG. 9 shows a view looking downward at the plurality of plurality of angled steppes 73 located at the inner lower periphery of the blending cup 64. The center spike 71 that imparts the radial kinetic energy force and the pulverize force (as described below) can also be seen in FIG. 10.

Referring back to FIG. 9, the shear force can be imparted by a plurality of stepped shelves 75 located at the outer lower periphery of the blending cup 64. FIG. 10 shows a view looking downward at the plurality the plurality of stepped shelves 75 located at the outer lower periphery of the blending cup 64.

Referring again to FIG. 9, the pulverize force can be imparted by the lower center spike 71 in combination with a plurality of fins 77 located at the upper periphery of the blending cup 64 on the cap 66. Referring to 11, a cross-sectional view of the blending cup 64, cap 66, and seal assembly 68 of FIG. 7 taken along the line C-C of FIG. 8 is seen. FIG. 11 shows a view looking upward at the plurality of plurality of fins 77 located on the cap 66.

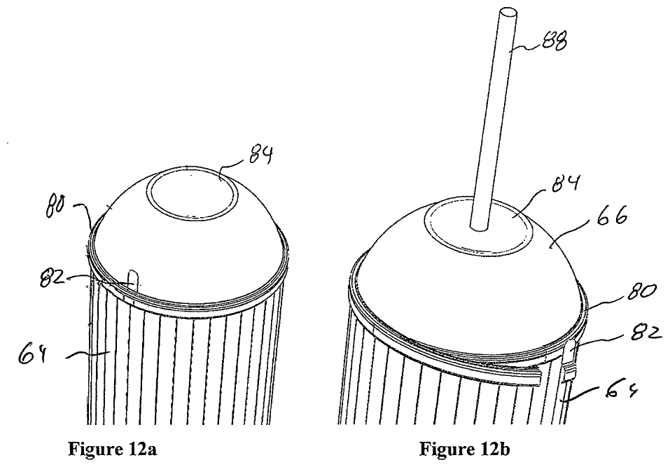

Referring to FIG. 12, a perspective detailed view of an embodiment in which the blending cup 64 and cap 66 are sealed with the beverage ingredients contained therein at the point of manufacture is seen. FIG. 12a shows the sealed blending cup 64 and cap 66. The blending cup 64 and cap 66 can be sealed during manufacturing—with the ingredients contained therein—by utilizing a shrink seal 80. In an embodiment, the seal assembly can comprise a shrink seal 80. The shrink seal 80 can include a tear tab 82 that can be utilized for shrink seal 80 removal. The access aperture 70 defined in the central recess 69 of the cap 66 is sealed by a suitable lidding stock 84, such as for example foil. As seen in FIG. 12b, the access aperture 70 can be accessed in the completed beverage by either removing or piercing the lidding stock 84 with for example a straw 88.

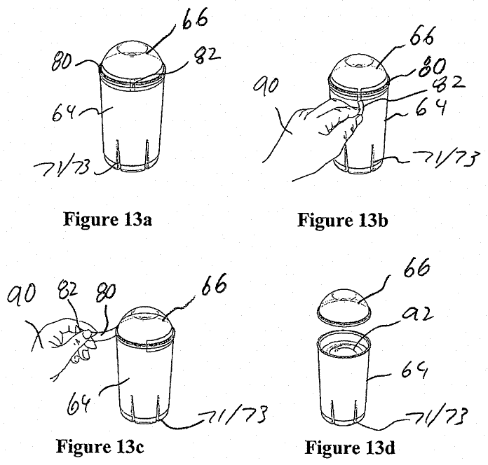

In FIG. 13 a user 90 can additionally access the beverage contents 92 of the blending cup 64 by grasping the tear tab 82 as seen in FIG. 13b and removing the strippable shrink seal 80 as seen in FIG. 13c. Thus, the cap 66 can be removed and the beverage contents 92 can be accessed by for example a spoon (not shown).

In operation, the voice-coil motor magnet structure 19 and coil structure 21 impart periodic stimulating forces to the reaction mass 15 and the shaker platen 17 securing the smoothie blending cup, cap, and sealing assembly 24. Via the third mass 13, secured to the reaction mass 15 via at least one biasing member 47, the grounded base plate 11 secured to the third mass 13 via at least one biasing member 51, and the shaker platen 17 secured to the reaction mass 15 via at least one biasing member 32, this force is driven into resonance. This resulting resonance motion is a up and down movement imparted upon the shaker platen 17 and in turn is applied to the blending cup, cap, and seal assembly 24 and thus upon the smoothie ingredients contained therein. The smoothie blending cup 64 comprising structure to generate at least two forces applied upon the smoothie ingredients. The pulverizing force can be imparted upon the smoothie ingredients by a lower center spike 71 in combination with a plurality of fins 77 located at the upper periphery of the blending cup 64. The shear force can be imparted upon the smoothie ingredients by a plurality of stepped shelves 75 located at the outer lower periphery of the blending cup 64. The rotational-kinetic energy force can be imparted upon the smoothie ingredients by a plurality of angled steppes 73 located at the inner lower periphery of the blending cup 64. The radial-kinetic energy force can be imparted upon the smoothie ingredients by the center spike 71.

While an apparatus in accordance with the principals of the present invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A blending appliance comprising:
a linear motor drive comprising a magnet and a coil;
the magnet secured to a reaction mass;
the coil secured to a shaker platen, the shaker platen adapted to secure a blending cup;
a third mass secured to the reaction mass via at least one biasing member;
a ground secured to the third mass via at least one biasing member; and
the shaker platen secured to the reaction mass via at least one biasing member;
such that the magnet and coil impart a force to the reaction mass and the shaker platen, which force is driven by the biasing members and the masses of the shaker platen, the reaction mass, and the third mass into resonance, thereby maximizing payload amplitude, minimizing forces transmitted to ground, and minimizing driver force.

2. The blending appliance of claim 1 further wherein the blending cup comprises structure to apply upon the ingredients at least a force selected from the group consisting of pulverizing force, shear force, rotational-kinetic energy force, radial-kinetic energy force, and combinations thereof.

3. The blending appliance of claim 1 further wherein, defining the third mass as m3; the reaction mass as m2; and the shaker platen as m1, the following equations of motion in the coordinate (Newtonian) form apply:
$${m}_{1} \frac{{d}^{2} {x}_{1}}{{dt}^{2}} = ( {c}_{1} + {c}_{2} ) \frac{{dx}_{1}}{dt} - {c}_{2} \frac{{dx}_{2}}{dt} + ( {k}_{1} + {k}_{2} ) {x}_{1} - {k}_{2} {x}_{2} + {f}_{1} ( t )$$
$${m}_{2} \frac{{d}^{2} {x}_{2}}{{dt}^{2}} = - {c}_{2} \frac{{dx}_{1}}{dt} + ( {c}_{2} + {c}_{3} ) \frac{{dx}_{2}}{dt} - {c}_{3} \frac{{dx}_{3}}{dt} - {k}_{2} {x}_{1} + ( {k}_{2} + {k}_{3} ) {x}_{2} - {k}_{3} {x}_{3} + {f}_{2} ( t )$$
$${m}_{3} \frac{{d}^{2} {x}_{3}}{{dt}^{2}} = - {c}_{3} \frac{{dx}_{2}}{dt} + {c}_{3} \frac{{dx}_{3}}{dt} - {k}_{3} {x}_{2} + {k}_{3} {x}_{3} + {f}_{3} ( t )$$

4. The blending appliance of claim 1 further wherein, defining the third mass as m3; the reaction mass as m2; and the shaker platen as m1, the following equations of motion in the Matrix form apply:
M\ddot{X}=C\dot{X}+KX+F
where the mass matrix (M), the damping matrix (C), the stiffness matrix (K), and the force matrix are:
$$M = ( \begin{matrix}{m}_{1} & 0 & 0 \\ 0 & {m}_{2} & 0 \\ 0 & 0 & {m}_{3}\end{matrix} ) ; C = ( \begin{matrix}{c}_{1} + {c}_{2} & - {c}_{2} & 0 \\ - {c}_{2} & {c}_{2} + {c}_{3} & - {c}_{3} \\ 0 & - {c}_{3} & {c}_{3}\end{matrix} ) ; K = ( \begin{matrix}{k}_{1} + {k}_{2} & - {k}_{2} & 0 \\ - {k}_{2} & {k}_{2} + {k}_{3} & - {k}_{3} \\ 0 & - {k}_{3} & {k}_{3}\end{matrix} ) ;$$
$$F = ( \begin{matrix}{f}_{1} ( t ) \\ {f}_{2} ( t ) \\ {f}_{3} ( t )\end{matrix} ) ;$$
where:
mᵢ=mass;
kᵢ=spring rate of spring;
cᵢ=damping coefficient of dash pot;
xᵢ=position of mass; and
fᵢ=applied force.

5. The blending appliance of claim 1 further comprising a plurality of guide shafts adapted to define vertical movement of the shaker platen, the guide shafts secured to the reaction mass.

6. The blending appliance of claim 5 wherein the plurality of guide shafts are contained on platen bushings on the shaker platen.

7. The blending appliance of claim 6 wherein the at least one biasing member securing the reaction mass to the shaker platen comprises a platen spring on the guide shafts contained between the platen bushing and a collar.

8. The blending appliance of claim 7 wherein the at least one biasing member securing the reaction mass to the shaker platen further comprises a second platen spring below the shaker platen on the guide shafts contained between the platen bushing and a collar.

9. The blending appliance of claim 1 further comprising a plurality of guide shafts adapted to define vertical movement of the reaction mass, the guide shafts secured to the third mass.

10. The blending appliance of claim 9 wherein the plurality of guide shafts are contained on reaction plate bushings on the reaction mass.

11. The blending appliance of claim 10 wherein the at least one biasing member securing the third mass to the reaction mass comprises a reaction spring on the guide shafts contained between the reaction plate bushing and a collar.

12. The blending appliance of claim 11 wherein the at least one biasing member securing the third mass to the reaction mass further comprises a second reaction spring on the guide shafts below the reaction mass contained between the reaction mass bushing and a collar.

13. The blending appliance of claim 1 wherein a blending cup, cap, and seal assembly are secured to the shaker platen.

14. The blending appliance of claim 13 wherein the blending cup, cap, and seal assembly are secured to the shaker platen by a hold down channel, a hold down stud, and a collar nut for the hold down stud.

15. The blending appliance of claim 1 further wherein the ground secured to the third mass via at least one biasing member comprises a grounded base plate.

16. The blending appliance of claim 1 further wherein the linear motor is a voice coil motor.

17. A blending cup comprising structure to generate at least two forces applied upon the smoothie ingredients, the forces selected from the group consisting of pulverizing force, shear force, rotational-kinetic energy force, radial-kinetic energy force, and combinations thereof.

18. The blending cup of claim 17 wherein the pulverizing force is imparted upon the smoothie ingredients by a lower center spike in combination with a plurality of fins located at the upper periphery of the blending cup.

19. The blending cup of claim 17 wherein the shear force is imparted upon the smoothie ingredients by a plurality of stepped shelves located at the outer lower periphery of the blending cup.

20. The blending cup of claim 17 wherein the rotational-kinetic energy force is imparted upon the smoothie ingredients by a plurality of angled steppes located at the inner lower periphery of the blending cup.

21. The blending cup of claim 17 wherein the radial-kinetic energy force is imparted upon the smoothie ingredients by a center spike.

22. The blending cup of claim 17 wherein blending cup is sealed at the point of manufacture, the seals remaining intact during transport, storage, blending, and vending.

23. The blending cup of claim 22 wherein blending cup and cap are sealed together at the point of manufacture by a shrink seal.

24. The blending cup of claim 22 wherein blending cap further defines an access aperture and the access aperture is sealed at the point of manufacture by a lidding stock.

25. The blending cup of claim 22 wherein the shrink seal includes a tear tab for removing the strippable shrink seal to remove the cap.
